(19) United States
(12) Patent Application Publication
(10) Pub. No.: US 2015/0219308 A1
(43) Pub. Date: Aug. 6, 2015

(54) Lighting device with a LED and an improved reflective collimator

(71) Applicant: KONINKLIJKE PHILIPS N.V., EINDHOVEN (NL)

(72) Inventors: Oliver Dross, Waalre (NL); Simon Eme Kadijk, Veldhoven (NL)

(21) Appl. No.: 14/423,274

(22) PCT Filed: Aug. 2, 2013
(86) PCT No.: PCT/IB2013/056346

§ 371 Date: Feb. 23, 2015

Related U.S. Application Data
(60) Provisional application No. 61/692,258, filed on Aug. 23, 2012.
(60) Provisional application No. 61/715,879, filed on Oct. 19, 2012.

(51) Int. Cl. F21V 7/04; F21V 29/51; F21V 29/60; F21V 5/04

(52) U.S. Cl. CPC F21V 7/04; F21V 5/04; F21V 29/51; F21V 29/60

(57) ABSTRACT

The invention relates to a lighting device (1) comprising a housing (8) with a light source connector for a LED (11) and a reflective collimator (3) and a refractive collimator (9) as well as to a method for their manufacture. The reflective collimator (3) comprises a plurality of reflective segments (4, 4′, 5, 5′, 6, 6′, 7, 7′), which are spaced apart from each other by means of air slits suitable for dissipation of heated air. The segments (4, 4′, 5, 5′, 6, 6′, 7, 7′) are adapted to reflect laterally emitted light generated by the light source (11) towards a direction which is substantially parallel to said main direction. Lighting devices according to this invention may have a compact design and an improved dissipation of the heat generated by the LEDs.

### FIELD OF THE INVENTION

The present invention relates to a lighting device comprising a housing with a light source connector adapted to contain at least one LED for emitting light in a main direction and a reflective collimator connected to the housing. The invention also relates to a method for the manufacture of such lighting device.

### BACKGROUND OF THE INVENTION

A lighting device of the in the opening paragraph mentioned type is known as such. For example, the U.S. Pat. No. 7,891,842-B2 discloses a lighting device with a LED positioned in a housing and a reflector attached to this housing. The reflector is designed as a generally truncated conical body which may substantially collimate the light emitted by the LED. A plurality of ventilation openings are formed in the reflective surface of the reflector body. These ventilation openings allow for dissipation of heat generated by the LED during operation of the lighting device. In order to improve the heat dissipation, an annular flange with additional openings is formed at the major end of the conical reflector body.

The known lighting device inherits different disadvantages. As shown in the Figures of the mentioned patent publication, the chosen reflector design for collimating light produced by the LED requires a ‘deep’ or ‘long’ reflector. So, the ‘aspect ratio’ (length/diameter) of the known reflector is rather high. Moreover, the ventilation openings in the reflector may disturb the reflection quality of the reflector. This disadvantage is especially problematic when the reflector is designed as a reflective collimator for emitting the light produced by the LED as a substantially parallel light beam. Finally, the dissipation of the heat generated inside the reflector by the LED is not optimal.

### OBJECT AND SUMMARY OF THE INVENTION

The present invention has the object to overcome or at least mitigate these and possible other disadvantages. In more detail, the present invention aims at providing a lighting device which combines a compact design with optimal collimation properties. The invented lighting device should moreover show improved heat dissipation.

These and possible other objectives are achieved with a lighting device comprising a housing with a light source connector adapted to contain at least one LED for emitting light in a main direction and a reflective collimator connected to the housing, wherein the collimator comprises a plurality of reflective segments, which are spaced apart from each other by means of air slits suitable for heat ventilation, which segments are adapted to reflect laterally emitted light generated by the light source towards a direction which is substantially parallel to said main direction, and the lighting device comprising a refractive collimator adapted to collimate centrally emitted light generated by the light source towards a direction which is substantially parallel to said main direction.

The invention is based on the insight acquired by the inventors that the compactness and heat dissipation of the known lighting device can be drastically improved by using a design in which the collimator is composed of a number of mutually separated reflective segments. These segments essentially are parts having a parabolic reflective contour with a different focal length (distance between focal point and vertex of a parabola). These segments are positioned in such manner in series, that an air slit is present between neighboring segments. An air slit of this type may also present between the housing and the segment neighboring the housing. However, latter type of air slit is not essential for the working of the present invention. The housing may be embodied as a substrate on which the light source is mounted. However, it may also be a bowl- or box-shaped container in which or on which the light source is positioned, if needed together with electronics and wiring. The refractive collimator is preferably embodied as an optical lens. In particular by the refractive collimator it is accomplished that also the central part of the light beam is issued as rays parallel to the main direction, contrary to, for example, a collimator which issues light over the whole light emission window and comprises only reflective segments. Furthermore, in a collimator comprising only reflective segments, the central segments (i.e. close to the optical axis or optical plane) extend almost parallel to the main direction thus rendering said collimator to be relatively deep and thus to have an unfavorable high aspect ratio. A Fresnel lens is most preferred as it maintains the compactness of the lighting device. Thus, the aspect ratio of the device will hardly or no change when such Fresnel lens is positioned on or inside the central part of the reflective collimator.

Preferably the reflective segments are ring-shaped, linear, round, or polygon-shaped as these are the most commonly used forms for reflectors. Apart from an outer reflective segment and a relatively central reflective segment, all (other, intermediate) reflective segments could be double-sided reflective segments. Double-sided reflective segments are to be understood as integral segments which are made in one-piece and are reflective on both sides, i.e. have a reflective first main surface and a reflective second main surface, generally with a mutually different contour. Alternatively double-sided segments are to be understood to comprise an arrangement and combination of two or more single-sided reflective segments with the non-reflective sides towards turned each other and which single-sided reflective segments together virtually form an integral, one piece double-sided reflective segment. These reflective segments are held in position by a holder. In general the reflective collimator then works as follows:
a first reflective segment reflects by its first reflective main surface the light coming from the light source as once reflected light onto a second reflective segment which is in radial direction further away from a central axis or plane of the light beam as issued by the lighting device into the target direction, i.e. in the case of round reflective segments a reflective segment of greater overall diameter;
the corresponding second segment reflects by its second reflective main surface the once reflected light as double-reflected light into a direction substantially parallel to the target direction to a target area, which target direction generally corresponds to an optical axis of the lighting device. Tilt angles and extent/size of the first and second reflective segments, but this is generally applicable to all the reflective segments, are chosen in a way that essentially no blockage (shadowing) of direct or reflected light ray paths occurs and that essentially all, i.e. more than 90% or more than 95% or even 98% of the light from the light source is captured and collimated.

The optical concept collects and collimates all light from a Lambertian light source, which, for example, could be a LED, i.e. collimation efficiency approaches 100% (not considering relatively small reflection losses). The optical concept also works with a compact short arc high pressure gas discharge lamp or a halogen incandescent lamp, and it can be designed to cover a greater than a hemispherical solid angle of such a uniformly emitting light source.

Due to the design of segmented collimator, no long or deep reflective collimator body is necessary. So, the ‘aspect ratio’ of the lighting device can be designed to be relatively small. Moreover, relatively large air slits can be designed between the reflective collimator and housing as well as between neighboring reflective segments. The reflective segments can be thin and due to their orientation, the reflective segments show very little resistance to air flow. Thus, heat generated by the LED in the space defined by the housing and the collimator can now relatively easy ventilate to the surrounding by convection flow of air through these air slits. So, the presently invented design provides much freedom to achieve a low aspect ratio and an optimal design for heat dissipation at the front end of the lighting device.

As will be shown in more detail below, the reflective collimator of the invented design is especially suitable for collimating laterally emitted light. This is to be understood as light emitted under an angle larger than approximately 30° away from the main direction of the light emitted by the LED. Light emitted under smaller angles—generally referred to as centrally emitted light—may remain non-collimated or may be collimated by different means. Latter portion of the emitted light cannot be collimated efficiently by the reflective collimator as designed according to the present invention. The word ‘approximately’ indicates that, although an angle of 30° is considered to be optimal, the angle can also be chosen somewhat smaller or larger. Said angle may also be 25° or 35° or any angle in the range between 20° and 40°. The expression ‘substantially parallel’ means that the collimated light is parallel to the main direction of the emitted light with a variation of 20° at maximum, preferably 10° at maximum and most preferably 5° at maximum. The present invention is considered to be embodied both in lighting devices permanently comprising one or more LEDs as well as in devices being adapted for the uptake or exchange of LED(s) at the light source connector. Latter connector arranges for the electrical contact between the LED(s) and the electrical power of the lighting device.

Optionally, viewed in cross-section through the light source, transverse to the reflective segments and along the target direction, the double-sided reflective segments are arranged in a nested configuration. This arrangement of reflective segments renders that light rays from the source emitted at increasing off axis angles from the target direction, exit the light emission window at increasing radial distance from the center of the light emission window. In agreement with the Abbe Sine condition, collimators fulfilling such characteristics produce relatively constant magnification. The Abbe Sine condition is a condition that must be fulfilled by a lens or other optical system in order for it to produce sharp images of off-axis as well as on-axis objects at the target area. For lighting devices this translates into a good cut-off at the edges of the pattern.

An interesting embodiment of the presently invented lighting device has the feature that the light source connector is designed to comprise a plurality of LEDs positioned in a line, and wherein the reflective segments have a longitudinal shape and are positioned in pairs which run substantially parallel to the line defined by the LEDs. This embodiment is especially useful in so-called ‘line lighting’. In such embodiments, the individual segments of the pairs of reflector segments are positioned at the both sides of the ‘optical plane’ defined by the main direction of the light beams emitted by the plurality of LEDs during operation of the device.

In principle, the plurality of LEDs can be positioned in a curved line, but positioning them in a straight line is preferred. In latter design, the longitudinal reflective segments will also have a straight form, which form can be manufactured more easily than curved forms. The line of LEDs can be designed to have a single LED per light source position, but lines having two or more closely neighboring LEDs per light source position are also feasible. The LEDs positioned in the line be designed such that neighboring LEDs are close together, but neighboring LEDs in the line can also be at some preferably same distance. The LEDs can be positioned on a plane surface, but positioning the LEDs on stepped structures is also possible.

Another interesting alternative embodiment of the presently invented lighting device has the feature that the light source connector is designed to comprise one or more LEDs positioned in a densely packed array, and wherein the reflective segments are ring-shaped. This embodiment of the invention is especially interesting for spot lighting applications, in which the light source substantially resembles a compact disc like light source. Said light source can comprise a single high power LED or a number of similar LEDs positioned close together. Compact designs using three, four or seven LEDs symmetrically positioned at close distance are favored in this respect. The LEDs may be available as individual LED packages or as so-called chip-on-board arrays.

Within the scope of the present invention, segments of various ring-shapes can be applied in the lighting device. Thus, reflective collimators having multi-angular, rectangular and square shaped reflective segments are all feasible as well as reflective collimators comprising elliptically shaped reflective segments. Preferred however are reflective segments having a substantially circular shape. Latter design of the invented lighting devices most closely resembles the currently popular spot light designs. The mentioned shapes are defined by the contour obtained by the cross section made through the segments and a plane perpendicular to the mean optical axis of the LEDs.

A further interesting embodiment of the lighting device according to the present invention is characterized in that neighboring reflective segments are positioned such that during operation of the device substantially no light emitted by the light source can escape between neighboring segments and substantially no shadow is cast from a segment on a neighboring segment. Undesired light losses are present in case that non-reflected light can escape via a gap between neighboring segments of the collimator. Shadow areas on the reflective surfaces of the reflector segments are also undesired. Such shadows reduce the functional portion of the surface of the collimator. Moreover, the presence of such areas reduces the maximal achievable intensity of the collimated light beam. Furthermore, such shadows imply a sub-optimal design of the reflective collimator, leading to an unnecessary increase of reflector material and to a decrease of the heat dissipation. Also a lighting device according to the invention is envisaged in which the reflective collimator is partly arranged in between the light source and the light emission window but also partly arranged beyond the light source viewed upstream along the optical axis. This embodiment has the advantage that essentially only collimated, double-reflected light parallel rays are issued from the lighting device.

Also interesting is the lighting device which has the inventive feature that the reflective surface of the reflective segments is curved. It is noted that substantial collimation of the light emitted by the LED(s) is already obtained when the reflective surface of the segments is flat or, more preferably, has a multifaceted structure with flat facets. However, increased collimation is obtained in case that the reflective surface is curved. The contour of the curved surface may be circular; however a parabolic contour is preferred as such contour may provide theoretically maximal collimation. In latter embodiment, the reflective surfaces of the various segments form parts of a series of parabola which mutually differ in having a different focal length. These segment parts are positioned such that their focal points (in case of ring-shaped collimators) or focal lines (in case of longitudinal-shaped collimators) coincide. In latter design, the light source should be positioned in the focal point or focal line of the thus positioned reflector segments.

The contours of the part of the reflective segments in cross-section, i.e. transverse to their length-direction, can be chosen to be straight, elliptic, or parabolic, but two aspheric profiles have certain advantages, especially when designed for extended sources. Additionally or alternatively it is possible to provide an overlay structure, for example mirror segmentation or facets, onto the reflective segments. This structure can be a deviation from the contours of each reflective segment or faceting in both the radial and rotational direction. Attention is also given to the embodiment of the invented lighting device in which at least a part of the reflective surface of the reflective segments comprises reflective facets. These facets may be flat or with curvature in one or two directions. They also may be concave or convex. Such facets may enhance the uniformity of the collimated beam produced by the LEDs and/or perform fine-tuning of beam shaping and/or color mixing of the light pattern. In case that LEDs are used which emit radiation of different wavelengths, such facets may enhance the color mixing in the light beam emitted by the lighting device. Highest beam uniformity and color mixing are obtained if the facets comprised in the reflective segments extend both in radial and rotational direction.

Another attractive embodiment of the invented lighting device is characterized in that the reflective surfaces of the reflector segments are made of an optically transparent dielectric material which comprises radially extending TIR grooves. In such design, light rays striking the reflective surface undergo a first refraction at the front surface of the reflector, subsequently a first total internal reflection (=TIR) at a groove surface, than a second total internal reflection at a groove surface and finally a second refraction at the rotated front surface. If the TIR grooves are formed so that each pair of groove surfaces substantially forms a 90° angle, the trajectory of the beam as described basically acts in the same way as a single specular reflection.

As detailed before, centrally emitted light is to be understood as light emitted by the light source under a small angle of approximately 30° or less from the main direction. Such light is difficult to collimate by the reflector segments of the invented lighting device. Collimation of such light implies very small reflection angles on the reflection surface of the segments. Moreover, the positioning of the neighboring segments required for reflecting this portion of the emitted light should be very close to each other. In view thereof, the use of a refractive element such as a lens is preferred for collimating the central portion of the light as emitted by the LED. The word ‘approximately’ indicates that, although an angle of 30° is considered to be optimal, the angle can also be chosen somewhat smaller or larger. Said angle may also be 25° or 35° or any angle in the range between 20° and 60°. The expression ‘substantially parallel’ means that the collimated light is parallel to the main direction of the emitted light with a variation of 20° at maximum, preferably 10° at maximum, most preferably 5° at maximum.

Another embodiment of interest of the presently invented lighting device has the characteristic that the at least one LED of the device is thermally connected to the reflective segments via connection means, and that the reflective segments and the connection means comprise heat conducting material. The features of this embodiment enable an efficient transfer of the heat generated by the LED(s) to the reflective segments. This transferred heat may subsequently be dissipated by convection streams of air, which streams can easily pass the reflector segments via the open air gaps. During passing the segments, they can take over the heat of the segments and distribute that to the outside world.

The plurality of reflective segments is maintained in the right position and orientation with regards to the light source by means of a number of connection means. In practice these connection means also maintain the neighboring reflective segments in mutual stable and right position. These connection means additionally connect the segments and the LED(s), usually via the housing of the device, which may be embodied as a LED substrate, a LED sub mount and/or a separate heat sink on which the LED(s) is (are) positioned. The number and type of connection means depends from the dimensions of the longitudinal or ring-shaped reflector segments. In practice, two, three or four symmetrically positioned connection means are used in lighting devices having a ring-shaped collimator. The number of connection means in lighting devices having reflective segments with longitudinal shape depends on the length of these segments. The projected area occupied by the connection means is small compared with the space defined by the air gaps, typically less than 10% and more typically less than 2%. So, the heat dissipation by convection streams through the air gaps is hardly or even not influenced by the presence of these connection means. Moreover, the optical light emission is also marginally influenced by the presence of the connection means.

In principle different types of material can be used, both for the reflective segments and for the connection means. So, segments of plastics are feasible. Such materials usually have no heat transporting properties. Therefore, segments of metals are preferred as they have far better heat transporting properties. Generally, segments and connection means being at least largely composed of copper, aluminum or their alloys appear to be very suitable in the present embodiment of the invented lighting device, especially in view of their excellent heat transfer properties.

A further interesting embodiment of the invention has the feature that the connection means comprise a heat-pipe. In a heat pipe, heat is absorbed at the hot end by vaporizing a working liquid trapped within the heat pipe. The resulting gas condenses at the cold side of the heat pipe, depositing the latent heat there. Capillary forces and gas convection are the mass transport forces that provide very high heat transfer unobtainable with solid metal heat conductors. The presence of such heat pipes may considerably increase the transfer of heat from the LED to the reflective collimator segments.

Another improved embodiment of the presently invented lighting device has the feature that it comprises means for generating a forced air flow along the reflective segments. This measure may cause a significantly increased dissipation of the heat produced by the LED in the lighting device. Application of this measure may be needed if passive convection flow of air heated by LED substrate and/or the reflective segments results in insufficient heat dissipation. The forced air flow may be generated by blowing or sucking Thus, heated air may be blown out the housing through the air slits between the reflective segments, whereby the air intake can be at the back side of the lighting device. In a different embodiment the airflow may be reversed, sucking air in from the collimator side and blowing heated air out to the back side of the lighting device. In yet another embodiment cool air may be sucked in through some of the air slits between the reflective segments, whereas heated air may be blown out between other reflective segments. The forced air flow is preferably realized by means of an efficient air mover, like a fan, a blower or a synthetic jet which may be implemented in the lighting device. Such forced air flow may dissipate the heat sufficiently, so that the properties of the LED and the driver electronics are not negatively influenced by the heat generated by the LED(s).

Another interesting embodiment of the invention has the feature that wherein the light source connector contains at least one LED. This LED may be permanently attached in the light source connector or may be detachable or exchangeable. Various types of LEDs can be applied, such as white light (phosphor-coated) LEDs, or LEDs irradiating at different wavelengths. Both low power and high power LEDs can be used within the course of the present invention.

Optionally neighboring reflective segments are positioned such that during operation essentially no, for example <=10%, <=5% or <=2%, light emitted by the light source can propagate between said neighboring segments without being reflected and essentially no, for example a surface fraction of <=10%, <=5% or <=2% of the illuminated area of the segments, shadow is casted from a segment on a neighboring segment by light from said light source. Undesired light losses of un-reflected light escaping via optical gaps between the reflective segments are thus counteracted. Shadow areas on the reflective segments of neighboring reflective segments are also undesirable as such shadows reduce the functional portion of the reflective segments and hence of the collimator. Moreover, the presence of such shadow area reduces the maximal achievable intensity of the collimated light beam. Furthermore, such shadow areas imply a sub-optimal design of the reflective collimator, leading to an unnecessary increase of reflector material.

The lighting device could be an integral lighting device comprising the light source preinstalled and permanently fixed on the base, rendering the advantage that the light source with the collimator is pre-aligned in the lighting device. Alternatively, in the case of easily alignable light sources, it could be a non-integral lighting device in which a separate light source is to be mounted on the base and, optionally, also is removable therefrom.

The invention further relate to a luminaire comprising at least one lighting device according to the invention. Generally such a luminaire comprises next to the lighting device, a housing and at least one electrical contact as a base for connecting it to mains. Preferably the luminaire comprises at least two lighting devices each with a respective target emission direction, at least two of said respective targeted emission directions either being the same or different. When the lighting devices have the same target direction high brightness spot illumination is obtainable. When the target directions of the respective lighting devices are mutually different, desired light distributions or light patterns are obtainable.

The invention also relates to a method for the manufacture of a lighting device. This method comprises the steps of method comprises the steps of 1) manufacturing the reflective segments of the reflective collimator, the connection means and optionally the refractive collimator, 2) positioning and connecting the reflective segments, the connection means and optionally the refractive collimator as a collimator part, and 3) aligning and connection the collimator part to the LED. These different parts can be manufactured as individual parts, which are connected and aligned afterwards. Thus, the refractive collimator may be manufactured as a Fresnel lens of glass or plastics, for example by injection molding. The connection means may be manufactured as ‘spider arms’ from plastics, for example by injection molding, or preferably from a heat conductive material, for example by means of dye casting or stamping from thick metal sheets. The reflective collimator segments may be manufactured from plastics, for example by injection molding and subsequent metallization of the reflective surface, for example by a metal like aluminum or silver. The segments are preferably manufactured from metal like aluminum or aluminum alloy by means of stamping or deep drawing from reflective sheets or slats. These three types of collimator parts may be subsequently connected via snap-in features and optically aligned together with the LED in order to form the lighting device according to the present invention.

A preferred method of manufacturing the invented lighting device has the feature that the reflective collimator segments, the connection means and optionally the refractive collimator are manufactured in a single step by means of injection molding. Such manufacture of the collimator part as a single piece in one step is especially useful in mass production facilities. The three (or two in case that the refractive collimator is not available in the lighting device) simultaneously formed collimator elements need not be mutually aligned afterwards, but still need to be aligned to the LED in order to manufacture the complete lighting device. The injection molding may be performed using an optically transparent dielectric material, like a plastic. The molded part need to be metallized, for example by metal evaporation of aluminum or silver, especially on the reflective surfaces of the reflective collimator segments. During metallization, it is essential to keep the refractive collimator (by example formed as a Fresnel lens) free of the metallization, for example by masking this collimator element. Manufacturing the reflective collimator segments and the connection means in a single step and adding the refractive collimator to the manufactured collimator part is also a feasible option. With the indicated methods, collimator parts of various dimensions can be manufactured.

### BRIEF DESCRIPTION OF THE DRAWINGS

The invention is elucidated in more detail by means of the embodiments described below and the drawing, in which

FIG. 1 shows a 3-D representation of a first embodiment of the lighting device according to the present invention,

FIG. 2 shows a 3-D representation of a second embodiment of the lighting device according to the present invention,

FIG. 3 shows a cross section through the optical axis of the lighting device according to the second embodiment,

FIG. 4 shows the same cross section with an indication of the heated air circulation

FIG. 5 shows a cross section of a further embodiment of the lighting device according to the present invention, and

FIG. 6 shows a cross section of still another embodiment of the lighting device according to the present invention.

It is stressed that the Figures are schematically and not to scale. Identical elements of the lighting device presented in different Figures are indicated as much as possible with the same reference number.

### DESCRIPTION OF EMBODIMENTS

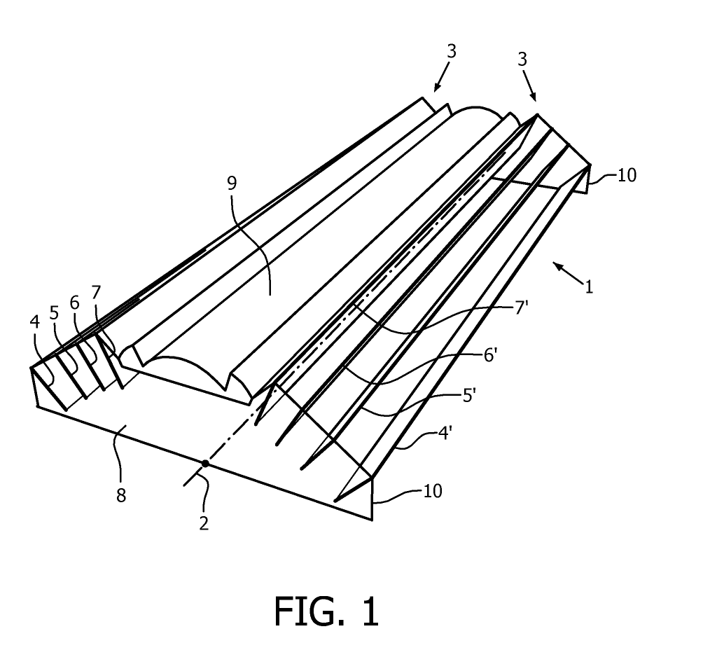

In FIG. 1, a first embodiment of a lighting device 1 according to the present invention with very compact design is depicted. The lighting device has a light source connector comprising a plurality of LEDs (not shown in detail), which are positioned on straight (dotted) line 2. During operation of the lighting device, the plurality of LEDs emits light in a main direction, defining an optical plane (not shown) which extends perpendicular to substrate 8 on which the LEDs are positioned. In this embodiment, substrate 8 represents the housing of the light device. If needed, the substrate can also be occupied in a bowl- or box-shaped housing. The necessary wiring and driver electronics needed for driving the LEDs is not shown for clarity. They may be attached to or incorporated in substrate 8 or on a sub mount on which substrate 8 may be positioned.

Lighting device 1 further comprises a reflective collimator 3, being composed of a plurality of reflective segments 4, 4′, 5, 5′, 6, 6′, 7 and 7′. These eight reflective segments have a longitudinal shape and are positioned in four pairs (4, 4′), (5, 5′), (6, 6′) and (7, 7′) in the lighting device. The two segments of each pair of segments are positioned symmetrically on opposite sides of the optical plane. The segments moreover run substantially parallel to line 2 defined by the LEDs. The surfaces of the segments which face the optical plane are reflective and curved such that they have a parabolic contour. The longitudinal segments have been positioned such that they are mutually spaced away and that they are also spaced away from substrate 8 on which the LEDs are positioned. So, air slits are present between neighboring segments and between the housing (here substrate 8) containing the light sources (here the plurality of LEDs) and the segment being positioned closest to the light source. The segments are manufactured of a plastic material which has been provided with a metallization layer of aluminum on the reflective surfaces. In an alternative embodiment, the segments may also be manufactured of a heat conductive metal or metal alloy.

Lighting device 1 also comprises a refractive collimator being designed as a longitudinally shaped Fresnel lens 9. The optical plane of lens 9 substantially coincides with the above-mentioned optical plane defined by the plurality of LEDs. Lens 9, reflective segments 4, 4′, 5, 5′, 6, 6′, 7, 7′, and substrate 8 with the LEDs are mutually connected with schematically depicted connection means 10, which are positioned on both ends of lighting device 1. The refractive collimator has been manufactured of a dielectric material. The connection means have been manufactured from sheet metal, plastic or another suitable material.

During operation of the lighting device, the light generated by the LEDs is collimated by reflective collimator 3 and refractive collimator 9. More particularly, the portion of the light generated by the LEDs, which is emitted under an angle of more than approximately 30° away from the main direction of the emitted light (the laterally emitted light), is reflected by the segments of the reflective collimator towards a direction substantially parallel to said main direction. On the other hand, the portion of the light generated by the LEDs, which is emitted under an angle less than approximately 30° away from the main direction of the emitted light (the centrally emitted light), is refracted by the Fresnel lens towards a direction substantially parallel to said main direction. Both collimated light portions are combined to a single collimated light beam being visible as a single light line. It has been shown that with the here-described compact lighting device a good collimated light line can be produced.

Heat generated by the LEDs during operation of the lighting device can be dissipated by the LED and the housing (here: substrate 8) in the space surrounded by substrate 8 and both collimators 3 and 9. Due to the presence of air slits between neighboring reflective segments and between the light source and its nearest reflective segment, a passive air stream may be generated, which can enter and exit said space via the mentioned air slits. As a result, satisfactory heat dissipation is present in this embodiment of the lighting device according to the present invention.

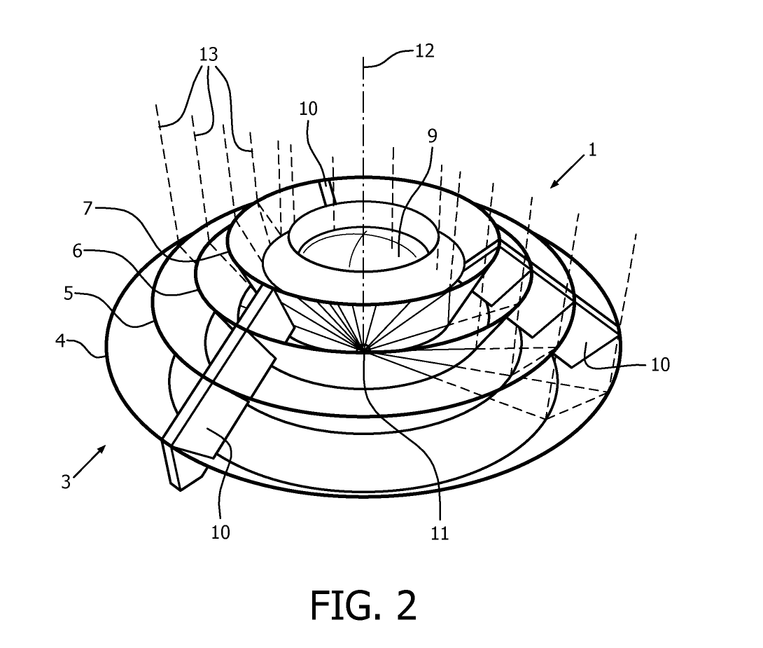

FIG. 2 shows a second embodiment 1 of a lighting device 1 according to the present invention, which also has a small aspect ratio. The lighting device has a light source 11 comprising a three LEDs (not shown in detail), which are positioned in a compact packing design. During operation of the lighting device, these three LEDs emit light in a main direction, defining optical axis 12. The necessary wiring and driver electronics needed for driving the LEDs is not shown for clarity. They may be positioned on or in the substrate on which the three LEDs are positioned, or on a sub mount on which this substrate may be fastened.

Lighting device 1 further comprises a reflective collimator 3, being composed of a plurality of reflective segments 4, 5, 6, and 7. These four reflective segments have a circular shape and are positioned symmetrically around optical axis 12 of the lighting device. The surfaces of the segments which face the optical axis 12 are reflective and curved such that they have a parabolic contour. The ring-shaped segments have been positioned such that they are mutually spaced and also spaced from the LEDs. So, air ventilation slits are present between neighboring segments. An additional air slit may be available between the housing (not shown) and the segment being positioned closest to the housing in or on which the light source is positioned. The segments are manufactured of a heat conducting material, typically aluminum or an aluminum alloy, by means of stamping or deep drawing from metal sheet. The so-produced reflective segments may additionally be provided with a reflective coating if the used material does not show sufficient reflectivity.

Lighting device 1 also comprises a refractive collimator being designed as a rotational-symmetrically Fresnel lens 9. This lens has been manufactured of a transparent dielectric material. The optical axis of lens 9 substantially coincides with the optical axis 12 as described before. The various components of the lighting device, namely lens 9, reflective segments 4, 5, 6, 7, and the substrate on which the LEDs are positioned (not shown) are mutually connected with three connection means 10, which are rotational-symmetrically positioned around the LEDs. The connection means 10 are being manufactured from a heat conducting material, typically aluminum or an aluminum alloy. The substrate is also provided with a metal layer in order to transport the heat generated by the LEDs 11.

During operation of the lighting device, the light generated by the LEDs is collimated by the reflective collimator 3 and the refractive collimator 9. A series of light beams 13 (all in a single plane X through optical axis 12) is indicated in the Figure. A portion of the light generated by the LEDs, which is emitted under an angle of more than approximately 30° away from the main direction of the emitted light (laterally emitted light), is reflected by the circular shaped segments of the reflective collimator towards a direction substantially parallel to said main direction. On the other hand, a portion of the light generated by the LEDs, which is emitted under an angle less than approximately 30° away from the main direction of the emitted light (centrally emitted light), is refracted by the Fresnel lens towards a direction substantially parallel to said main direction. Both collimated light portions are combined to a single collimated light beam formed as a single light beam. It has been shown that with the here-described compact lighting device a good collimated light beam can be produced.

Heat generated by the LEDs during operation of the lighting device will be conducted from the LEDs via the heat conductive layer on the substrate and the connection means 10 to the segments of the reflective collimator 3. Due to the presence of air ventilation slits between neighboring reflective segments and between the light source and its nearest reflective segment, a passive air stream may be generated due to temperature differences, which stream can enter and exit said space via the mentioned air slits. As a result, satisfactory heat dissipation is present in this embodiment of the lighting device according to the present invention.

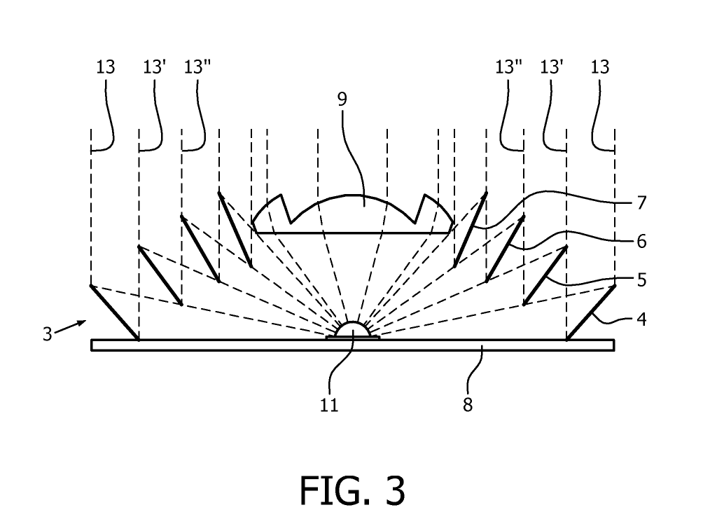

FIG. 3 shows a cross section of the lighting device 1 as shown in FIG. 2. More particularly, the cross section coincides with plane X mentioned before. This cross section shows the light source being composed of three LEDs 11, which are positioned in a compact packing design on substrate 8. Latter substrate (which forms the housing of the device) has been provided with a heat conductive metal layer for conducting heat generated by LEDs 11. The lighting device also comprises a reflective collimator 3 having a circular shape comprising reflective segments 4, 5, 6 and 7, as well as a refractive collimator 9. The four reflective segments all are curved, and, more precisely have a parabolic contour. Actually, the four segments are parts excised from paraboloids having mutually different focal lengths. A skilled person can select the focal lengths in such manner that slits with optimal widths between neighboring segments are obtained.

FIG. 3 clearly shows that the neighboring reflective segments are positioned such that substantially no light emitted by the light source can escape between neighboring segments and that substantially no shadow areas are present at any of the segments. Thus, segments 4 and 5 are positioned such that light beam 13 just strikes the beneath rim of segment 5 and the upper rim of segment 4. Due to this precise positioning no light can escape between segments 4 and 5 and no shadow areas are present on the upper rim of segment 4. Displacement of a segment with respect to the others along the direction of the optical axis 12 would result in such light escape or shadow areas.

While parabolic segments are the optimal shape for a small source in the point source approximation, or for an extended source, when intensity but not efficiency is the primary goal, for an extended source optimizations to the basic parabolic segment contour can be applied to avoid light loss and shadowing between the reflective segments. Such shape modifications may be applied the upper and lower edge of each segment. The upper edge of the reflective segments can be modified and extended to make sure all light from the extended source that passes below the bottom edge of the previous inner segment is captured to avoid light loss. Such extension can have another parabolic profile with its focal point at the bottom edge of the previous inner segment. On the bottom edge of a reflective element an elliptical section can be applied, where one focal point is the edge of the extended light source, while the other focal point is the top edge of the previous inner segment.

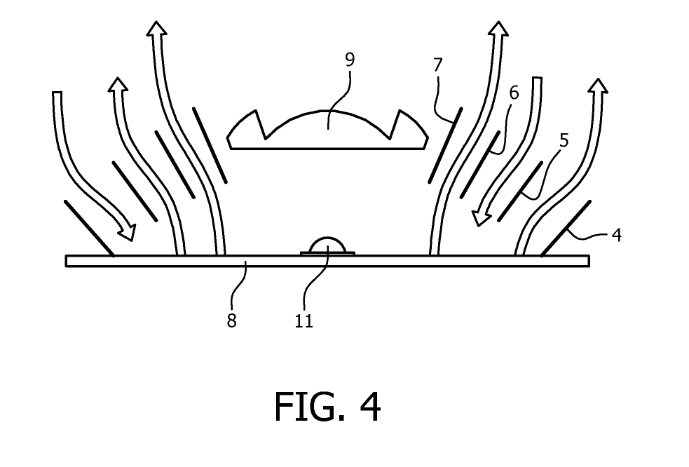

FIG. 4 schematically depicts in the invented lighting device the flow of air after being heated up by substrate 8 on which LEDs 11 are positioned. Thus, the heated air may escape from the space surrounded by the housing (here: substrate 8), reflective collimator 3 and refractive collimator 9 via air ventilation slits 13. An air circulation will cause exit of hot air from said space and entrance of cool air into said space by convection flow. In this embodiment, no air slit is present between segment 4 and the housing. However, such slit can be provided easily be recessing the housing accordingly.

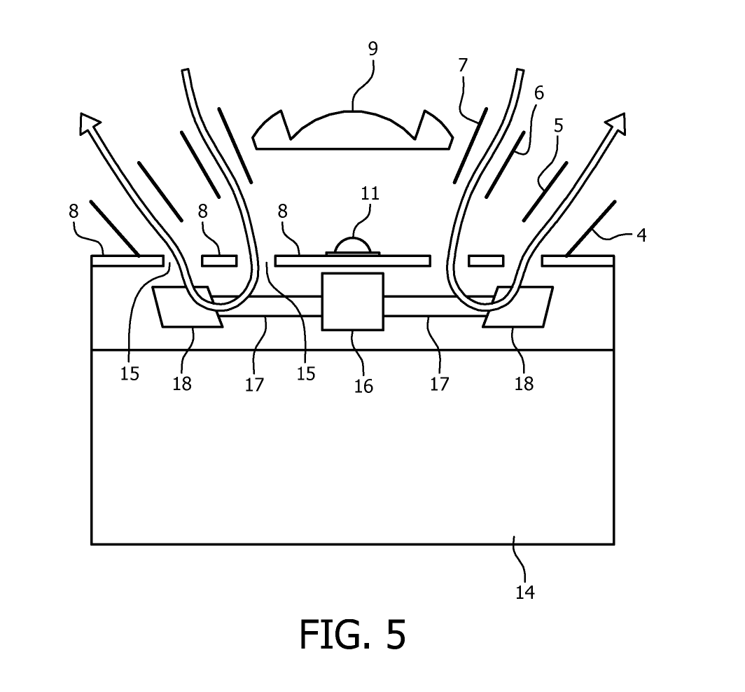

FIG. 5 shows the cross section of another embodiment of the presently invented lighting system, being designed for an improved active air circulation. Substrate 8 of this embodiment is positioned on a housing 14 for storing wiring and driver electronics (not shown in detail). Immediately under substrate 8, an air mover, in this case a fan, has been installed. Said fan comprises a powering unit 16, arms 17 and two or more blades 18. Upon powering the fan, the arms and blades start rotating and causing an air flow.

According to this improved design, through holes 15 have been made in the substrate 8 within the outer area defined by the maximum dimensions of reflective collimator 3. As through holes 15 are at different distances from the light source, an optimal air stream, powered by the fan, can be designed. The air stream can remove the hot air accumulated in the space between the housing 14 (including substrate 8) and both collimators 3, 9. It can also efficiently cool the reflective segments of collimator 3. This is especially interesting in case that the segments should function as a heat sink. This is very useful in case that the reflective segments and the connection means are made of heat conductive material and that they are in heat conductive contact with LEDs 11 (for example via substrate 8).

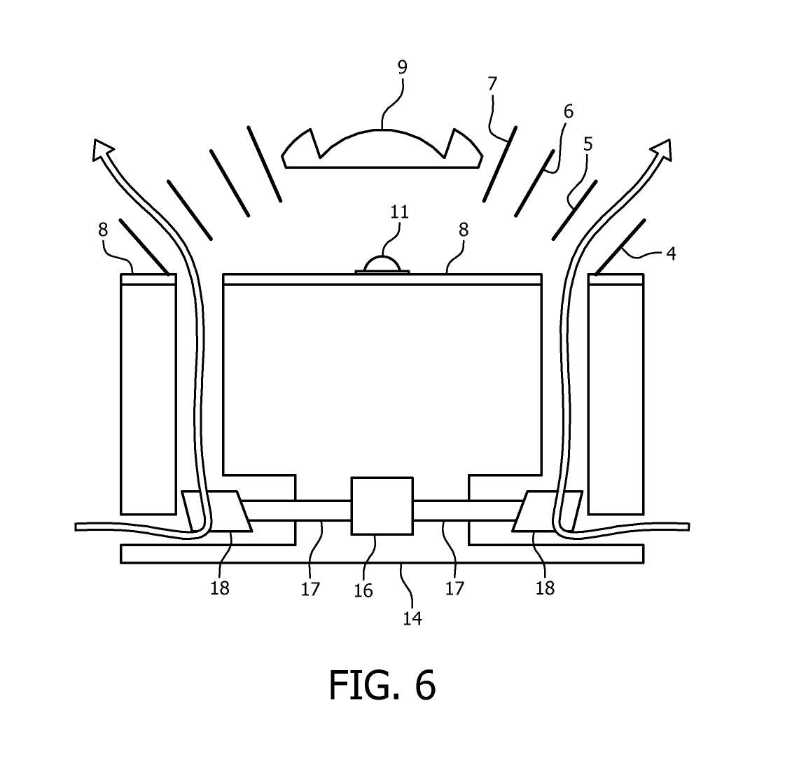

FIG. 6 schematically depicts still another embodiment of the invented lighting device. In this embodiment, housing 14 is provided with channels 16. These channels comprise at least one air mover, such as a blower, a fan or a synthetic jet. In the present embodiment a fan has been installed in the bottom of housing 15. Said fan comprises a powering unit 16, arms 17 and two or more blades 18. Upon powering the fan, the arms and blades start rotating and causing an air flow. Although the arrows indicate a forced air flow from the bottom towards the top, an oppositely directed air flow also works well. In many applications it appears to be practical to remove the air to the front (lens) of the device, as indicated by the arrow in the Figure. The air mover could for example create an over pressure within the space defined by substrate 8 and both collimators 3 and 9 so that the air may escape via the air gaps positioned between the neighboring reflective segments. This design would efficiently cool the driver electronics, which is integrated in housing 14.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A lighting device comprising
a housing with a light source connector adapted to contain at least one LED for emitting light in a main direction, and
a reflective collimator connected to the housing,
wherein the collimator comprises a plurality of reflective segments, which are spaced apart from each other by means of air slits suitable for heat ventilation, which segments are adapted to reflect laterally emitted light generated by the light source towards a direction which is substantially parallel to said main direction,
a refractive collimator positioned on or inside a central part of the reflective collimator and adapted to collimate the centrally emitted light generated by the light source towards a direction which is substantially parallel to said main direction.

2. A lighting device according to claim 1, wherein the light source connector is designed to comprise a plurality of LEDs positioned in a line, and wherein the reflective segments have a longitudinal shape and are positioned in pairs which run substantially parallel to the line defined by the LEDs.

3. A lighting device according to claim 1, wherein the light source connector is designed to comprise one or more LEDs positioned in a densely packed array, and wherein the reflective segments are ring-shaped.

4. A lighting device according to claim 1, wherein neighboring reflective segments are positioned such that during operation of the device substantially no light emitted by the light source can escape between neighboring segments and substantially no shadow is casted from a segment on a neighboring segment.

5. A lighting device according to claim 1, wherein the reflective surface of the reflective segments is curved.

6. A lighting device according to claim 1, wherein at least a part of the reflective surface of the reflective segments comprises reflective facets.

7. A lighting device according to claim 6, wherein the facets comprised in the reflective segments extend both in radial and rotational direction.

8. A lighting device according to claim 7, wherein the reflective surfaces of the reflector segments are made of an optically transparent dielectric material which comprises radially extending TIR grooves.

9. A lighting device according to claim 1, wherein the at least one LED of the device is thermally connected to the reflective segments via connection means, and wherein the reflective segments and the connection means comprise heat conducting material.

10. A lighting device according to claim 9, wherein the connection means comprise a heat-pipe.

11. A lighting device according to claim 1, wherein the device comprises means for generating a forced air flow along the reflective segments.

12. A lighting device according to claim 1, wherein the light source connector contains at least one LED.

13. Method for the manufacture of a lighting device according to claim 1, which method comprises the following steps:
manufacturing the reflective segments of the reflective collimator, the connection means and the refractive collimator,
positioning and connecting the reflective segments, the connection means and the refractive collimator as a collimator part, and
aligning and connection the collimator part to the LED.

14. Method according to claim 13, wherein the reflective collimator segments, the connection means and optionally the refractive collimator are manufactured in a single step by means of injection molding.

15. Method according to claim 13, wherein the reflective segments and the connection means are composed of a dielectric material, which is provided with a metallization layer.
